(19) United States
(12) Patent Application Publication
(10) Pub. No.: US 2015/0341067 A1
(43) Pub. Date: Nov. 26, 2015

(54) CARRYING CASE FOR MOBILE PHONES

(71) Applicant: Zaneta Truchalska, Des Plaines, IL (US)

(72) Inventor: Zaneta Truchalska, Des Plaines, IL (US)

(21) Appl. No.: 14/286,608

(22) Filed: May 23, 2014

(51) Int. Cl. H04B 1/3827; H04B 1/3883; H04M 1/04

(52) U.S. Cl. CPC H04B 1/385; H04M 1/04; H04B 1/3883; H04B 2001/3855

(57) ABSTRACT

An attachment apparatus for an electronic device includes a mounting plate adapted to be secured to the electronic device and a housing unit including a cord that is movable between a retracted position and an extended position. A connector element attaches to a distal end of the cord and is removably engageable with the mounting plate. A base portion extending from the housing unit is adapted to engage with the mounting plate when the cord is in a retracted position.

### FIELD OF THE TECHNOLOGY

The present disclosure relates to devices that are used to tether personal articles, so that the personal articles cannot be accidently dropped and/or misplaced. More particularly, the present disclosure relates to devices for retractably tethering portable electronic devices, such as mobile phones.

### BACKGROUND

Mobile phones and other portable electronic devices are indispensable tools in people's everyday lives. Mobile phones, especially smartphones, are not only used as communication tools, but also function as PDAs (personal digital assistants), cameras, GPS (Global Positioning Systems) etc. As a result, loss or misplacement of a mobile phone can significantly inconvenience a user. Because mobile phones are cordless and small, mobile-phone users often find, at one point or another, that they have lost or misplaced their phones during use. Mobile phones can easily be dropped on the ground or even into water. Such drops may result in irreparable damage to the mobile phone. The loss or drop may not only require repair, but also expose important personal information of the user stored on the mobile phone. Furthermore, a dropped phone may also present bodily endangerment to a user. In the past, users have been injured or even killed attempting to retrieve their phone from the water or train tracks.

The present disclosure provides protection from loss or drops by providing an attachment apparatus that allow for easy access and retrieval of a mobile phone, a smartphone, or a PDA whenever needed.

### SUMMARY OF THE DISCLOSURE

An object of the present disclosure is to provide an attachment apparatus to retractably secure an electronic device. In an exemplary embodiment, the attachment apparatus includes a mounting plate adapted to be secured to the electronic device and a housing unit. The wearable housing unit includes a cord that is movable between a retracted position and an extended position. A connector element is attached to a distal end of the cord and is removably engageable with the mounting plate. A base portion extending from the housing unit is adapted to engage with the mounting plate when the cord is in the retracted position.

In other exemplary embodiment, the attachment apparatus can also include at least one battery to charge the electronic device when the electronic device is mounted to the base portion.

Other features and advantages will be, or will become, apparent to one skilled in the art upon examination of the following figure and detailed description. It is intended that all such additional features and advantages included within this description be within the scope of the claims, and be protected by the following claims.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIGS. 1A, 1B and 1C are the front, side and back views, respectively, of an exemplary embodiment of an attachment apparatus;

FIG. 2 is a planar view of an exemplary embodiment of a mounting plate;

FIGS. 3A and 3B are front and side views, respectively, of the embodiment of FIGS. 1A, 1B, and 1C, showing the connector element in an extended position from the housing unit and disengaged from the short-line connector of the mounting plate;

FIG. 4 is a planar view of another exemplary embodiment of a mounting plate mounted on a mobile phone;

FIG. 5 is a planar view of another an exemplary embodiment of the attachment apparatus with a holster base portion adapted to engage with the mounting plate in FIG. 4;

FIG. 6 is a cut-away view of another exemplary embodiment of the attachment apparatus which can charge a mobile phone;

FIG. 7A is a perspective view of the attachment apparatus with a mobile phone in the holster-like base portion of the attachment apparatus according to another exemplary embodiment of the present disclosure; and

FIG. 7B is a perspective view of the attachment apparatus in FIG. 7A, when the phone is in use.

### DETAILED DESCRIPTION OF THE EMBODIMENTS

The exemplary embodiments below describe an attachment apparatus for securing an electronic device such as a mobile phone, a PDA, a small tablet computer, a GPS, a pager, or the like. Although the present disclosure is illustrated to support a mobile phone in the exemplary examples, the present disclosure is not limited to mobile phone use.

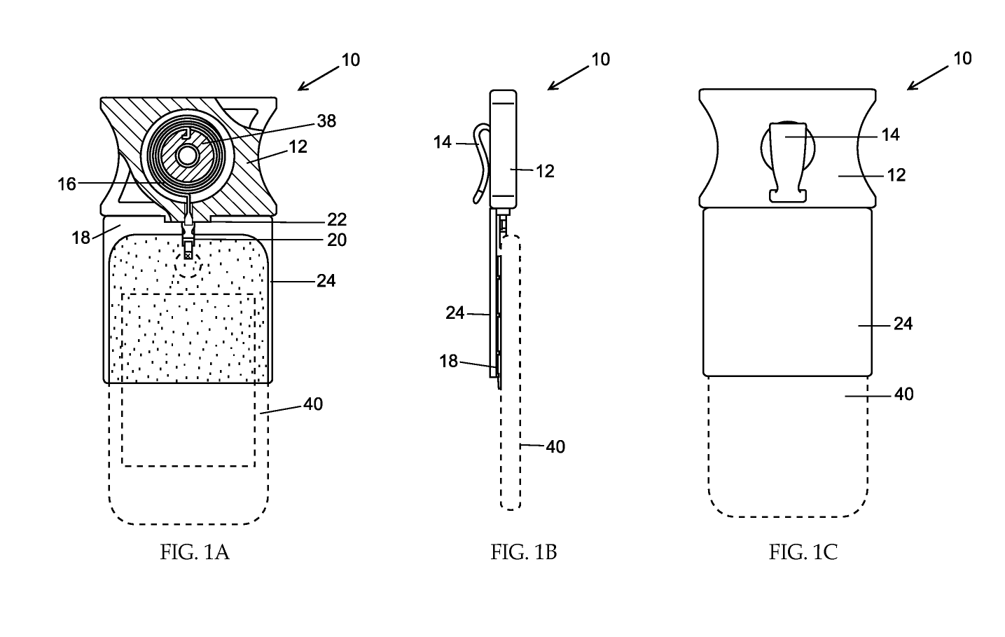

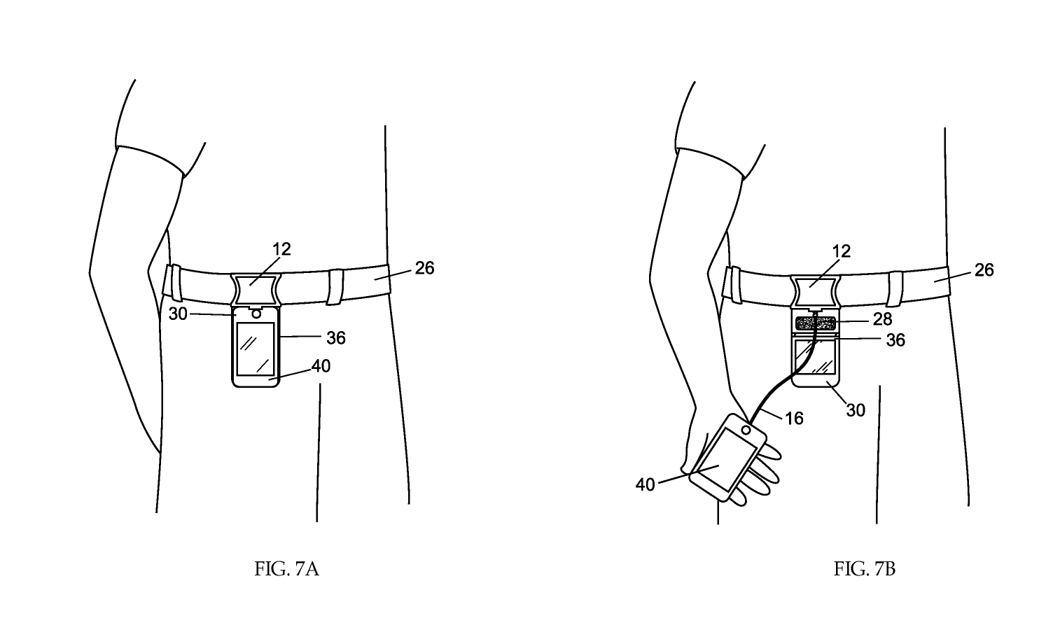

FIGS. 1A, 1B and 1C illustrate the front, side and back views of an exemplary embodiment of an attachment apparatus 10. The attachment apparatus 10 includes a wearable housing unit 12. As shown in FIGS. 1B and 1C, the housing unit 12 includes a rear external surface, to which a mounting mechanism 14 is connected to permit the housing unit 12 to be secured to a person or an object, such as a belt, a pocket, a belt loop, a backpack, a vehicle sun visor, a purse or any other object that can be engaged by the mounting mechanism. In some embodiments, the mounting mechanism 14 may comprise a belt clip as shown in FIGS. 1B and 1C and be mounted to a belt 26 as shown in FIGS. 7A and 7B. The mounting mechanism 14 can also include, but not limited to, a cloth pin, a peg, a key clip, a ring or a combination thereof. The mounting mechanism could also comprise a magnet set designed to clamp a surface between a magnet mounted on the rear external surface and a secondary magnet. The housing unit 12 can have any external shape. In particular, the housing unit can be made of various shapes in order to match the various types of the base portion or the various types of electronic devices. It should also be noted that the housing unit 12 need not comprise an enclosure.

In an exemplary embodiment, the housing unit 12 further includes a cord 16 that is movable between a retracted position and an extended position. The cord 16 is shown positioned inside the housing unit 12, but it may also be positioned outside the housing unit 12. In some embodiments, the housing unit 12 further comprises a spring-loaded spool 38 rotatably disposed within the housing unit 12, wherein the cord 16 is at least partially wound about the spool assembly when in a retracted position. The distal end of the cord 16 is secured to a connector element 22. A mounting plate 18 is mounted to a mobile phone 40 and includes a short-line connector 20. The connector element 22 is removable attachable to the short-line connector 20. When the phone is in use, the cord 16 extends and is unwound from the spool 38 under a pulling force on the mobile phone 40. When the force is removed, the cord 16 automatically retracts into the housing unit 12 under a bias from the spring-loaded spool 38. The mobile phone 40 is thus prevented from falling down to the ground or into water. The mechanism for extending and retracting the cord 16 in this embodiment is merely exemplary and a person skilled in the art can make many variations to the shown embodiment. For example, elastic cords, or other winding mechanisms may be used. Different types of cords 16 may also be implemented in the apparatus. The cord 16 may be colored, may glow in the dark, or even include embedded LEDs or other light systems allowing it to illuminate.

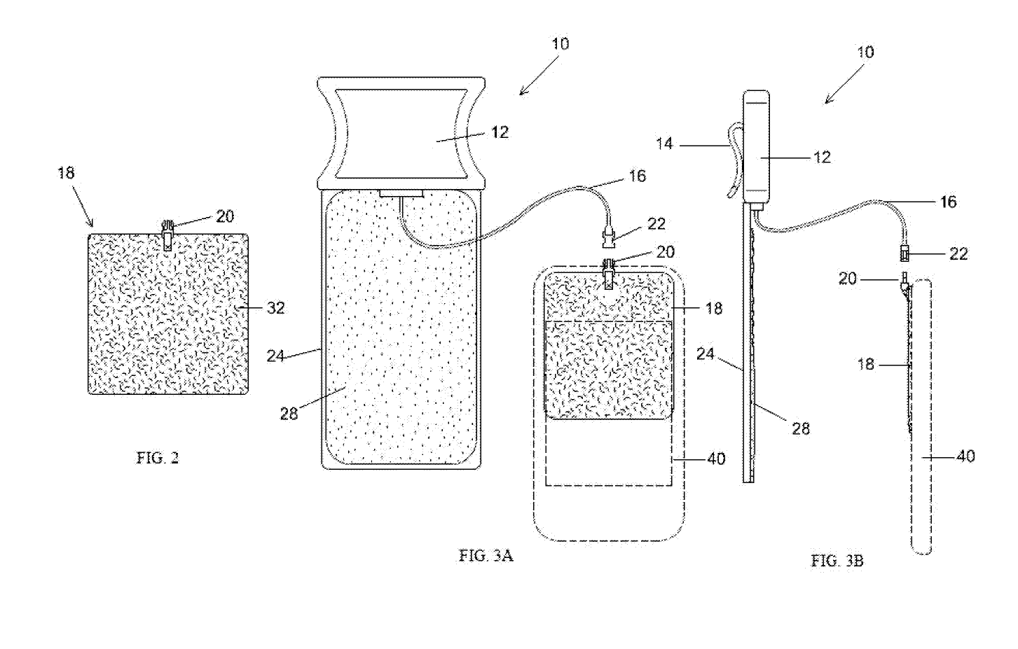

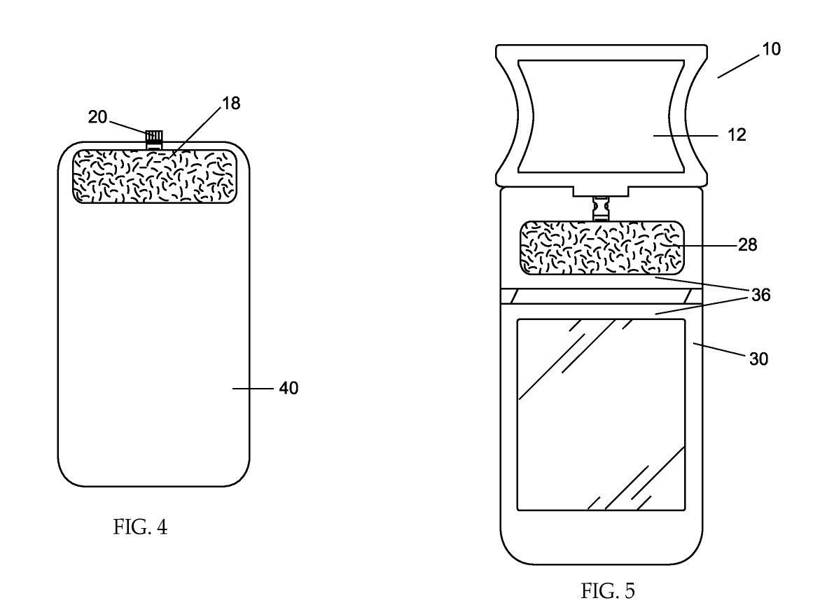

As shown in FIGS. 2, 3A, 3B and 4, the attachment apparatus 10 interacts with a mounting plate 18, which is attached to a mobile phone 40 by an attachment mechanism. In some embodiments, as shown in FIGS. 3A and 4, the mounting plate 18 is attached to the mobile phone 40 by an adhesive. Different attachment mechanisms can be used to attach the mounting plate to a mobile phone. For example, the mounting plate 18 could be in a shape adapted to clasp a mobile phone. Other attachment mechanisms can be used, including but not limited to, glues, snaps, screws or ties. The mounting plate 18 can also be connected via a plug into a receptacle on the phone such as charging plugs etc.

In the present embodiment, as shown in FIGS. 3A and 3B, the mounting plate 18 includes a short-line connector 20 which is removably engageable with the connector element 22 to connect the cord 16 to the attachment apparatus 10. With reference to the exploded views of the connector element 22 attached to the cord 16 extending from the housing unit 12 and the short-line connector 20 shown in FIGS. 3A and 3B, it can be seen that the short-line connector 20 can be removably connected to the connector element 22 by a side-release buckle connector in some embodiments. It should be noted that the short-line connector 20 can also be engaged to the connector element 22 by various other methods, including but not limited to, female/male pin-socket connectors, USB-like connectors, firewire connectors, snaps, or the like. The attachment apparatus 10 can also include a quick-release mechanism for readily disengaging the short-line connector 20 on the mounting plate 18 from the connector element 22, so that a user can conveniently or readily disengage the mobile phone 40 from the attachment apparatus 10 when the user needs to separate the phone from the attachment apparatus 10 for charging or for other purposes, such as connecting to a computer. This quick-release mechanism can be a button, a switch or the like. In the present embodiment, the buckle is a side-release buckle which allows a quick release of the short-line connector 20 disengaging from the connector element 22.

As shown in FIG. 1A, the attachment apparatus 10 also includes a base portion 24. The base portion 24 extends from the housing unit 12 and is adapted to engage with the mounting plate 18 when the cord 16 is in a retracted position. In some embodiments, the mounting plate 18 can be secured to the base portion 24 using Velcro or other hook-and-loop fasteners. In general, a hook and loop fastener comprises a hook component and a loop component. In the present embodiment, the mounting plate 18 also includes a Velcro loop component 32 as shown in FIG. 2 and the base portion 24 includes a Velcro hook component 28 which mates with the Velcro loop component 32 as shown in FIGS. 3A and 5. The Velcro component 28 could also be replaced with a magnet that corresponds to a magnet on the mounting plate 18 to secure the mounting plate 18 to the base 24. Or, the mounting plate 18 could be made from a metallic material and be attracted to a magnet on the base 24. Alternatively, the base portion 24 could be replaced with a sleeve attached to the housing unit 12. In such an embodiment, the sleeve could have two open ends: one for insertion of the phone 40 and one on the opposing end to allow the connector element 22 to extend into the sleeve.

Preferably, the mounting plate 18 is made of a material that will not add much extra weight to the mobile phone 40. When the mobile phone 40 is not in use, the mobile phone 40 will retract back towards the base portion 24 and be retained on the base portion via the Velcro. The Velcro or other hook-and-loop fasteners preferably do not cover the entire area of the base portion 24, so the base portion 24 can include some other material, such as rubber, leather or plastic, preferably at the edge of the base portion body, to facilitate detaching or separating the mounting plate 18 from the base portion 24. In an additional embodiment, the mounting plate 18 could be eliminated and the connecting element 22 could attach to a short-line connector 20 that is built into a replacement battery cover on the back plate of the phone 40.

The base portion 24 can be engaged with the mounting plate 18 through various other means, such as hook-and-loop fasteners, snaps, adhesives, magnets, magnetic material, mechanical fasteners, friction mechanisms, zippers, hinges, buckles, buttons, holster and a combination of these. In some embodiments, the base portion can be made of leather or other soft material, so that when the mobile phone is in use, the attachment apparatus 10 requires less space or looks better on users, and more importantly, the base portion 24 will not be uncomfortable for the user. The base portion 24 can also comprise other material, such as artificial leather, suede, fabric, plastic, metal, rubber and any combination of these, and similar materials may be used to provide a holster 30 on the base portion 24 as described further below.

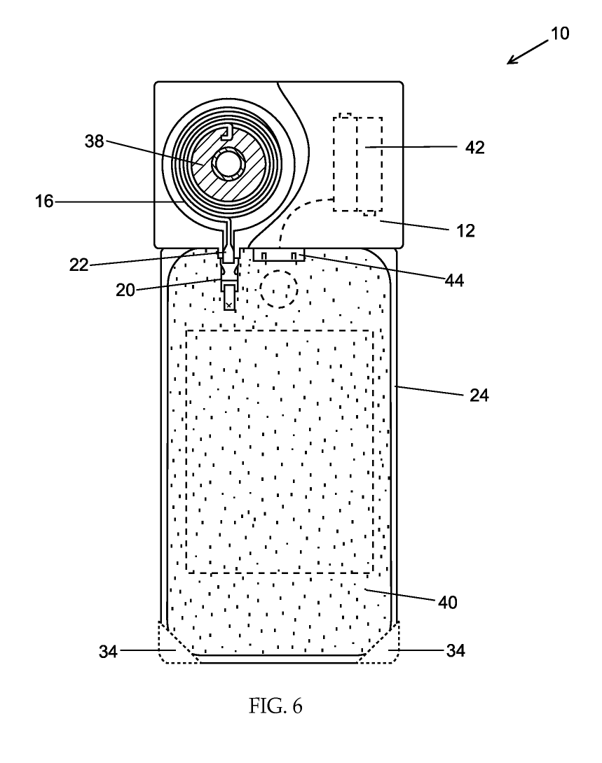

In some embodiments, the base portion 24 can also include one or two tabs 34 make it easier to disengage the base portion 24 from the mounting plate 18. In an exemplary embodiment as shown in FIG. 6, the base portion 24 includes two tabs 34 at each bottom corner of the base portion 24 to engage the mobile phone 40 on the base portion 24.

FIGS. 5, 7A and 7B illustrate another embodiment of the attachment apparatus 10, wherein the base potion defines a holster 30. As mentioned above, the holster 30 can be made of any material, such as plastic, leather, suede or the like. In some embodiments, as shown in FIG. 5, the holster 30 has an open front which allows a user to easily view the mobile phone 40 without taking it out of the holster 30. The mobile phone 40 is preferably positioned upside down, so it is only convenient for the user, but not others, to see the mobile phone, for example, to read any received instant messages. The mobile phone 40 may be secured by one or two straps 36 in the front of the holster 30. Other mechanisms include, but are not limited to hook-and-loop fasteners, Velcro, snaps, adhesives, magnets, magnetic material, mechanical fasteners, friction mechanisms, zippers, hinges, buckles, buttons, holster and combinations thereof. In some embodiments, the holster 30 comprises a clear front. It could be made of transparent plastic or other transparent material.

In some embodiments, the attachment apparatus 10 can further include a locking mechanism (not shown) for locking the cord 16 at any desired length. The mechanism can be a button or a switch, located on any appropriate position of the attachment apparatus 10, preferably adjacent to the spring-loaded spool 38 to intersect the arcuate path along which the spool rotates, to allow a user to pull the mobile phone 40 away from the attachment apparatus 10 a desired distance and then engage the suspension of the cord 16 retraction to give the mobile phone slack at a desired length. When the user finishes using the mobile phone, the user can retract the apparatus 10 by releasing the lock mechanism and the cord 16 is automatically retracted to a wound position.

In some embodiments such as that shown in FIG. 6, the attachment apparatus 10 further comprises at least one battery 42 inside the housing unit 12 and a means for charging the mobile phone 40 using the power of the battery 42. The mobile phone 40 can be charged by the battery 42 when it is placed on the base portion 24. In some embodiments, the base portion 24, or the housing unit 12, comprises at least one charging plug 44 enabling the mobile phone 40 to be charged through the charging plug 44 by the power of the battery 42. The charging plug 44 could be any charging plug adapted for various types of mobile phones. In some embodiments, the cord 16 can also carry current so that the mobile phone 40 can also be charged through the cord 16. In such an embodiment, the connector element 22 and short-line connector 20 could be replaced with a charging plug that can removably lock in place in the charging port of the phone 40. In this embodiment, the mounting plate 18 could be eliminated. The battery 42 can be any rechargeable or non-rechargeable disposable battery; alternatively, the battery 42 could be one or more photovoltaic cells. It should be noted that the battery could also be positioned in the base portion 24 or outside the housing unit 12, for example, when the battery 42 includes one or more photovoltaic cells. In some embodiments wherein the battery 42 is rechargeable, the attachment apparatus 10 can further comprise an AC adapter (not shown), or other power supply means, to recharge the attachment apparatus 10 itself from an external power source.

Alternatively, the mobile phone 40 can be charged by inductive charging when it is mounted to, or close to, the base portion 24. In some embodiments, the housing unit 12, or the base portion 24, comprises a means for converting electrical energy to an electromagnetic field, which is capable of providing electricity to a properly equipped portable electronic device, such as a mobile phone, capable of converting the electromagnetic energy to electricity to charge the battery of the portable electronic device. In an exemplary embodiment, the means for converting electrical energy to an electromagnetic field comprises a circular coil of conductive wire (not shown). Such coil of wire is preferably located inside the housing unit 12. The circumference, thickness of the wires and the number of wires in the coil are selected in a manner such that the desired electromagnetic field is produced when connected to a source of electricity.

It will be understood that the embodiment of the present disclosed attachment apparatus described and illustrated is merely exemplary and a person skilled in the art can make many variations to the shown embodiments. For example, the housing unit can be configured in many different ways. The size, shape and location of the attachment area and connector element can also be changed as desired. Finally, the means of attachment between the connector element and the electronic device can be altered in many ways. All such alternate embodiments and modifications are intended to be included within the scope of the present disclosure as defined below in the claims.

What is claimed is:

1. An attachment apparatus for an electronic device, said attachment apparatus comprising:
a mounting plate adapted to be secured to said electronic device;
a housing unit including a cord that is movable between a retracted position and an extended position;
a connector element attached to a distal end of said cord, said connector element removably engageable with said mounting plate; and
a base portion extending from said housing unit adapted to engage with said mounting plate when said cord is in said retracted position.

2. The attachment apparatus according to claim 1, further comprising a quick-release mechanism for readily disengaging said mounting plate from said connector element.

3. The attachment apparatus according to claim 1, further comprising a spring-loaded spool assembly rotatably disposed within said housing unit, wherein said cord is at least partially wound about said spool assembly when in a retracted position.

4. The attachment apparatus according to claim 1, wherein said base portion is engaged with said mounting plate through a means selected from a group consisting of hook-and-loop fasteners, Velcro, snaps, adhesives, magnets, magnetic material, mechanical fasteners, friction mechanisms, zippers, hinges, buckles, buttons, holster and a combination thereof.

5. The attachment apparatus according to claim 1, further comprising a mounting mechanism on said housing unit for mounting said attachment apparatus to a person or an object.

6. The attachment apparatus according to claim 5, wherein said mounting mechanism comprises a mechanism selected from a group consisting of a belt clip, a cloth pin, a peg, a key clip, a ring, at least one magnet or a combination thereof.

7. The attachment apparatus according to claim 1, wherein said base portion comprises a material selected from a group consisting of leather, artificial leather, suede, fabric, plastic, metal, rubber and any combination thereof.

8. The attachment apparatus according to claim 1, further comprising a locking mechanism for locking said cord at a desired length.

9. The attachment apparatus according to claim 1, wherein said base portion defines at least one tab extending from at least one edge of said base portion and adapted to support said electronic device.

10. The attachment apparatus according to claim 1, wherein said base portion defines a holster.

11. The attachment apparatus according to claim 10, wherein said holster includes a cover portion further comprising transparent material.

12. The attachment apparatus according to claim 1, further comprising at least one battery and a means for charging said electronic device using power from said at least one battery.

13. The attachment apparatus according to claim 12, wherein said base portion further comprises at least one charging plug enabling said electronic device to be charged using power from said at least one battery.

14. The attachment apparatus according to claim 12, wherein said electronic device can be charged using power from said at least one battery through said cord.

15. The attachment apparatus according to claim 12, wherein said means for charging comprises wireless charging.

16. The attachment apparatus according to claim 12, wherein said at least one battery comprises a rechargeable battery, and said attachment apparatus further comprises a means for charging said rechargeable battery from an external power source.
